(19) United States
(12) Patent Application Publication
(10) Pub. No.: US 2026/0227923 A1
(43) Pub. Date: Aug. 6, 2026

(54) Score-Based Dual Bank Refresh Arbitration

(71) Applicant: Google LLC, Mountain View, CA (US)

(72) Inventors: Anirban Majumder, Bengaluru (IN); Aravind Matta, Bangalore (IN); Hitender Singh Rathore, Bangalore (IN); Sukant Dewangan, Bengaluru (IN); Pandithurai Sangaiyah, Bangalore (IN)

(73) Assignee: Google LLC, Mountain View, CA (US)

(21) Appl. No.: 19/636,064

(22) Filed: Apr. 1, 2026

Related U.S. Application Data
(60) Provisional application No. 64/017,813, filed on Mar. 26, 2026.

(51) Int. Cl. G06F 3/06

(52) U.S. Cl. CPC G06F 3/0632; G06F 3/0604; G06F 3/0631; G06F 3/0673

(57) ABSTRACT

An apparatus and method for adaptive memory refresh scheduling utilize a score-and-filter-based arbitration logic to select bank pairs for refresh operations. A score generation logic determines priority scores for memory banks based on current operational states, including bank page states and transaction histories. A multi-stage filtering process identifies eligible banks by evaluating timing constraints and bank-refresh window requirements. A dual-stage arbitration logic processes the priority scores of the eligible banks to identify an optimal bank index and bank group pair. The arbitration logic employs parallel arbiters and weighted summation logic to select a winning bank index for generating a dual-bank refresh command. By dynamically selecting refresh candidates based on real-time bank activity and state transitions, the system manages refresh scheduling to maintain high throughput and bank utilization across varying workload conditions. The disclosed technology is applicable to high-performance memory controllers, including those compliant with dual-bank refresh protocols.

### CROSS-REFERENCE TO RELATED APPLICATION

This application claims the benefit of U.S. Provisional Patent Application Ser. No. 64/017,813 filed on Mar. 26, 2026, the disclosure of which is incorporated by reference herein in its entirety.

### SUMMARY

An apparatus and method for adaptive memory refresh scheduling utilizing a score-and-filter-based arbitration logic to select bank pairs for refresh operations. A score generation logic determines priority scores for memory banks based on current operational states, including bank page states and transaction histories. A multi-stage filtering process identifies eligible banks by evaluating timing constraints and bank-refresh window requirements. A dual-stage arbitration logic processes the priority scores of the eligible banks to identify an optimal bank index and bank group pair. The arbitration logic employs parallel arbiters and weighted summation logic to select a winning bank index for generating a dual-bank refresh command. By dynamically selecting refresh candidates based on real-time bank activity and state transitions, the system manages refresh scheduling to maintain high throughput and bank utilization across varying workload conditions. The disclosed technology is applicable to high-performance memory controllers, including those compliant with dual-bank refresh protocols.

The present disclosure generally describes techniques and apparatuses, implemented on mobile devices (e.g., smartphones, tablets, or computing systems), directed at Score-Based Dual Bank Refresh Arbitration.

In general, a first aspect of the present document relates to an apparatus for score-based dual bank refresh (REFdb) arbitration. The apparatus includes score generation logic configured to generate a priority score for each of a plurality of memory banks based on an operational state of each memory bank. The apparatus also includes a filtering stage configured to identify a set of eligible memory banks from the plurality of memory banks based on at least one timing constraint or a refresh window constraint. Further, the apparatus includes arbitration logic configured to select a target bank index and a plurality of bank groups from the set of eligible memory banks based on arbitration of the priority scores. A command engine is configured to issue a dual-bank refresh command based on the target bank index and the plurality of bank groups.

This document also describes computer-readable media having instructions for performing the above-summarized method and other methods set forth herein, as well as systems and means for performing these methods.

This Summary is provided to introduce simplified concepts for score-based dual bank refresh arbitration, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of score-based dual bank refresh arbitration are described throughout the disclosure, with reference to the drawings. The use of the same reference numbers in different instances in the detailed description and the drawings indicates same or similar elements:

FIG. 1 illustrates a system-on-chip and memory controller architecture for score-based dual bank refresh arbitration;

FIG. 2 illustrates a hierarchical arbitration flow and filtering pipeline for score-based dual bank refresh arbitration;

FIG. 3 illustrates a finite state machine transition diagram for generating priority scores for score-based dual bank refresh arbitration;

FIG. 4 illustrates an LPDDR6 DRAM bank and bank group organization for score-based dual bank refresh arbitration;

FIG. 5 illustrates a high-level method for adaptive memory refresh for score-based dual bank refresh arbitration;

FIG. 6 illustrates a detailed operational flow for score-based dual bank refresh arbitration.

### DETAILED DESCRIPTION

The present disclosure generally describes memory subsystems where memory controllers coordinate the flow of data between processing units and memory ranks. These memory ranks are typically organized into multiple banks and bank groups that require periodic refresh operations to maintain the integrity of stored data. In these environments, coordinating refresh commands with active read and write traffic supports system responsiveness and improves available memory bandwidth.

The technology described herein provides an adaptive scheduling framework that utilizes real-time bank status information to intelligently determine the most appropriate time and location for issuing refresh commands. Rather than following a predetermined or fixed sequence of operations, the system can evaluate the operational state of individual memory banks to select candidates for refresh. This evaluation may involve monitoring various indicators, such as whether a bank page is currently open or closed, and whether the bank is subject to active row hits or conflicts. By identifying banks that are in a relatively “cold” or stable state, the system can schedule refreshes in a manner that reduces interference with ongoing memory accesses.

In some implementations, the system leverages multi-bank refresh capabilities to increase the overall efficiency of the refresh cycle. A multi-stage process may be used to filter potential refresh candidates through a series of timing and protocol constraints to identify a set of eligible memory banks. An arbitration process then processes priority scores associated with these eligible banks to select a target bank index and specific bank groups for the refresh operation. This dynamic selection process can mitigate the duration of memory blackouts during which banks are unavailable for standard traffic, thereby improving the quality of service for high-priority data streams.

The adaptive nature of the scheduling allows for optimization based on specific workload profiles or environmental conditions, such as fluctuations in operating temperature. In some applications, the scoring and arbitration logic may be configured to favor specific bank states, such as prioritizing the refresh of closed banks to avoid the latency associated with forcefully closing an active page. By aligning refresh operations with the sporadic or localized nature of memory traffic, the system promotes throughput and bank utilization across various operating scenarios.

### Example Environment

The following discussion describes an operating environment, techniques that may be employed in the operating environment, and various devices or systems in which components of the operating environment may be embodied. In the context of the present disclosure, reference is made to the operating environment by way of example only.

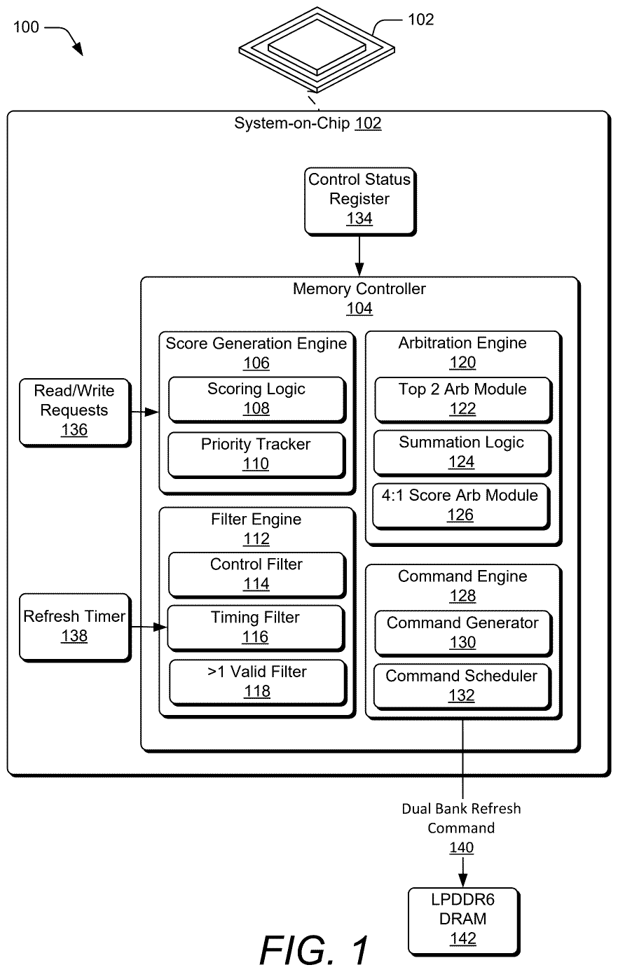

FIG. 1 illustrates an overall system diagram 100 including a system-on-chip 102 and a memory controller 104 architecture configured to support score-based dual bank refresh arbitration. The overall system diagram 100 provides a hardware environment where memory access operations and maintenance operations, such as refreshing memory cells, are managed to improve data integrity and system throughput. The system-on-chip 102 can include various processing components, for example, central processing units, graphics processing units, digital signal processors, neural processing units, or image signal processors, that generate memory traffic. The system-on-chip 102 hosts a memory controller 104 that manages communication with an external LPDDR6 DRAM, which may include one or more ranks, bank groups, and individual memory banks.

The memory controller 104 includes a score generation engine 106 that monitors the state of memory banks to determine their suitability for a refresh operation. The score generation engine 106 includes scoring logic 108 and a priority tracker 110. In some implementations, the scoring logic 108 evaluates incoming read/write requests and current bank states to assign a numerical value or priority level to each bank. For example, the scoring logic 108 can assign a higher score to a bank that is currently idle and a lower score to a bank that is currently servicing a high volume of row hits. The priority tracker 110 can maintain a history of bank activity or current state information, for example, whether a bank page is open, whether a page conflict has occurred, or the elapsed time since the last refresh for a particular bank index.

The memory controller 104 also includes a filter engine 112 that removes ineligible bank candidates from consideration during an arbitration cycle. The filter engine 112 includes a control filter 114, a timing filter 116, and a >1 valid filter 118. The control filter 114 can implement logic to track which banks have already been refreshed within a current refresh window, for example, by utilizing a 16-bit mask to prevent the same bank from being refreshed twice before other banks in a set have been serviced. The timing filter 116 receives inputs from the refresh timer 138 and monitors memory timing constraints, for example, tRC, tRP, or tRRD, to determine if a bank is timing-qualified to receive a refresh command. The >1 valid filter 118 evaluates groups of banks to facilitate dual bank operations. For example, if a protocol supports refreshing two banks simultaneously, the >1 valid filter 118 can invalidate a request if only one bank in a particular group is available, thereby supporting compliance with dual-bank command requirements.

An arbitration engine 120 within the memory controller 104 selects the best candidates for a refresh operation from the filtered set of banks. The arbitration engine 120 includes a top 2 arb module 122, a summation logic 124, and a 4:1 score arb module 126. The top 2 arb module 122 can evaluate scores for banks within a specific bank index group and select the two highest-scoring banks. The summation logic 124 can then aggregate the scores of the selected winners, for example, by calculating a weighted sum based on values provided by the control status register 134. The 4:1 score arb module 126 compares the aggregated results from multiple bank index groups to select a winning bank index. For example, the 4:1 score arb module 126 can compare four different paths, each representing a different bank index, and select the index that provides the highest total priority score.

The memory controller 104 further includes a command engine 128 that translates the arbitration results into hardware-level signals. The command engine 128 includes a command generator 130 and a command scheduler 132. The command generator 130 receives the winning bank index and bank group information from the arbitration engine 120 and constructs a dual bank refresh command 140. For example, the command generator 130 can format the command to target two specific bank groups that share the same bank index as required by the LPDDR6 standard. The command scheduler 132 coordinates the delivery of the dual bank refresh command 140 to the LPDDR6 DRAM 142. The command scheduler 132 can manage the insertion of the refresh command into the general command stream, for example, by finding an idle cycle or by momentarily pausing read/write traffic to support the maintenance operation.

The system-on-chip 102 includes a control status register 134 that stores configuration data, for example, priority weights, scoring thresholds, timing parameters, or operational modes. The memory controller 104 can access the control status register 134 to adjust the behavior of scheduling and arbitration logic. The memory controller 104 receives read/write requests 136 from various initiators within the system-on-chip 102. These read/write requests 136 can include a variety of command types, for example, row activation commands, column read commands, column write commands, precharge commands, or auto-precharge commands. Additionally, the memory controller 104 receives timing signals from a refresh timer 138. The refresh timer 138 can provide periodic triggers based on standardized refresh intervals, for example, tREFI, or adjusted intervals based on thermal conditions or workload demands.

In an example operational sequence, the score generation engine 106 continuously updates bank scores based on read/write requests 136 and state information in the priority tracker 110. When the refresh timer 138 indicates that a refresh is due, the filter engine 112 identifies which banks are timing-qualified and have not been refreshed in the current window. The control filter 114 can apply a mask to exclude recently refreshed banks, while the timing filter 116 checks for timing collisions. The >1 valid filter 118 then verifies that each bank index group has at least two valid candidates. The arbitration engine 120 processes the scores of the remaining valid candidates, with the top 2 arb module 122 selecting the highest-priority pair for each index and the 4:1 score arb module 126 selecting the overall winner. Finally, the command engine 128 transmits the dual bank refresh command 140 to the LPDDR6 DRAM 142.

The architecture illustrated in FIG. 1 supports a flexible scheduling environment where the system can adapt to varying memory workloads. For example, in a scenario where a graphics processor is heavily accessing a specific subset of banks, the scoring logic 108 can decrease the scores for those banks, while increasing the scores for idle banks being used by a lower-priority background process. This behavior allows the arbitration engine 120 to select the idle banks for refresh first, which helps avoid stalling the graphics processor. The control status register 134 provides a means for software or firmware to tune these scoring and arbitration behaviors without requiring a hardware redesign. By utilizing the combination of the filter engine 112 and the arbitration engine 120, the memory controller 104 manages refresh operations in a manner that supports high bandwidth availability for the system-on-chip 102 initiators.

### Example Devices and Systems

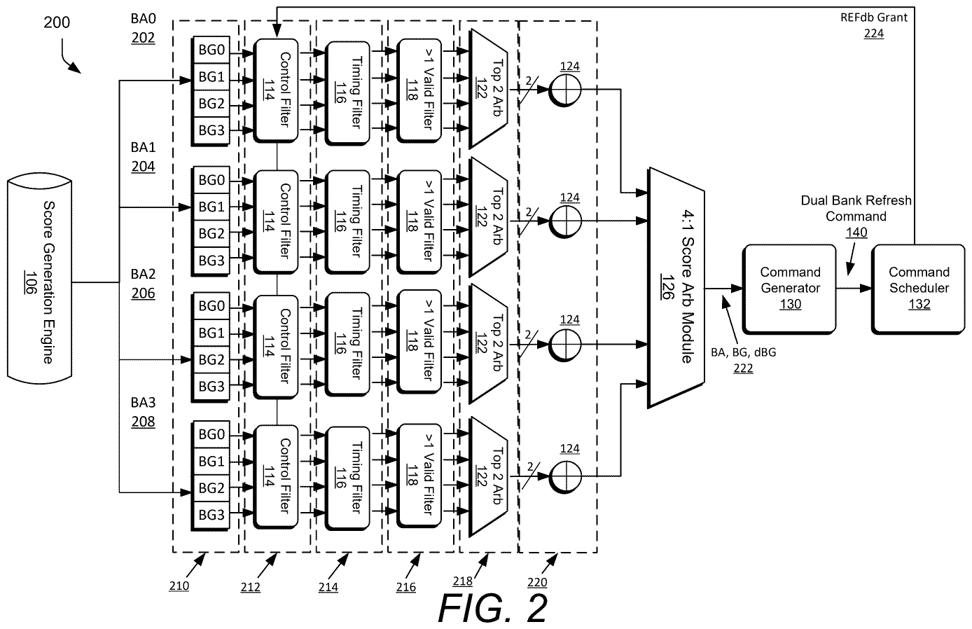

FIG. 2 illustrates a hierarchical arbitration flow and filtering pipeline for score-based dual bank refresh arbitration. The overall process flow 200 represents a structured approach for evaluating sixteen memory banks (categorized into four bank groups BG0, BG1, BG2, and BG3 across four bank address pathways) to identify an appropriate pair of banks for a refresh operation. The overall process flow 200 functions to receive priority data and refine that data through multiple filtering and arbitration layers to support efficient memory maintenance.

The score generation engine 106 initiates the process by providing priority scores for each of the sixteen memory banks. These scores represent the desirability of refreshing a particular bank based on its current operational state. The sixteenth banks are organized into four distinct pathways based on their bank address: a BA0 pathway 202, a BA1 pathway 204, a BA2 pathway 206, and a BA3 pathway 208. At the bank groups stage 210, each pathway provides four candidate scores corresponding to bank groups BG0, BG1, BG2, and BG3. This organization allows the system to evaluate candidates that share a common bank address index, which is a structural requirement for certain refresh protocols.

The sixteen candidate scores enter a control filtering stage 212. In this stage, a control filter 114 is provided for each of the four bank address pathways. The control filter 114 evaluates whether a specific memory bank has been refreshed too recently within a defined refresh window. To perform this evaluation, the control filter 114 receives a REFdb (dual-bank refresh) grant signal 224 as feedback from the end of the pipeline. For example, if bank group BG2 in the BA1 pathway 204 was selected for refresh in a previous cycle, the control filter 114 for the BA1 pathway 204 can apply a mask to that bank. This masking prevents the same bank from being refreshed again until the other banks in the rank have been serviced, thereby supporting compliance with protocol fairness requirements.

The remaining candidates proceed to a timing filtering stage 214. In this stage, a timing filter 116 for each pathway checks the candidate banks against DRAM AC timing constraints. The timing filter 116 monitors whether a bank is currently qualified to receive a refresh command based on its previous activity. For example, the timing filter 116 can check if a sufficient time interval, such as a row precharge time, has elapsed since the bank was last accessed. If a bank is currently busy or otherwise ineligible due to timing violations, the timing filter 116 invalidates the request for that specific bank group.

The filtered requests then reach a >1 valid filtering stage 216. A >1 valid filter 118 for each pathway determines if at least two bank groups remain valid within that specific bank address index. Because the system performs dual bank refreshes, a pathway with only one valid bank candidate cannot be used to generate a valid command. For example, if the BA3 pathway 208 contains only one valid bank group after the control and timing filters, the >1 valid filter 118 can invalidate all requests for the BA3 pathway 208 for the current arbitration cycle. This stage helps support the requirement that a dual bank refresh command must target exactly two bank groups.

The validated scores enter a top 2 arbitration stage 218. A top 2 arb module 122 for each pathway compares the priority scores of the valid bank groups. The top 2 arb module 122 identifies and selects the two bank groups with the highest priority scores. For example, if in the BA0 pathway 202, bank groups BG0 and BG3 have higher scores than BG1 and BG2, the top 2 arb module 122 selects BG0 and BG3 as the winners for that pathway. This selection identifies the best pair of banks to refresh if that specific bank address index is chosen for the final command.

The selected winners from each pathway enter a summation logic stage 220. A summation logic 124 in each pathway calculates a combined value for the winning pair of scores. In some implementations, the summation logic 124 performs a simple addition of the two priority scores. In other implementations, the summation logic 124 can apply specific weights or tuning parameters to the scores. For example, the summation logic 124 can produce a 2-bit or larger value representing the aggregate “refresh value” of a specific bank address. This aggregated result allows the system to compare the relative importance of refreshing different bank addresses against each other.

A 4:1 score arb module 126 receives the aggregate values from the BA0 pathway 202, the BA1 pathway 204, the BA2 pathway 206, and the BA3 pathway 208. The 4:1 score arb module 126 compares these four values and selects the pathway with the highest combined score. This winning pathway represents the most appropriate bank address index to refresh at the current moment. The 4:1 score arb module 126 then outputs the winning data 222, which includes the bank address (BA), the first bank group (BG), and the second bank group (dBG). For example, the output can indicate that bank address index 1 and bank groups 0 and 2 are the winners.

The winning data 222 enters a command generator 130. The command generator 130 constructs the dual bank refresh command 140 based on the selected indices. The command generator 130 formats the command packet to be compatible with the memory protocol, such as the LPDDR6 standard. This dual bank refresh command 140 is then forwarded to a command scheduler 132. The command scheduler 132 manages the final issuance of the command to the DRAM. When the command scheduler 132 issues the command, it also asserts the REFdb grant signal 224. This signal provides feedback to the control filter 114 to update the history of refreshed banks, completing the logic loop for the next arbitration cycle.

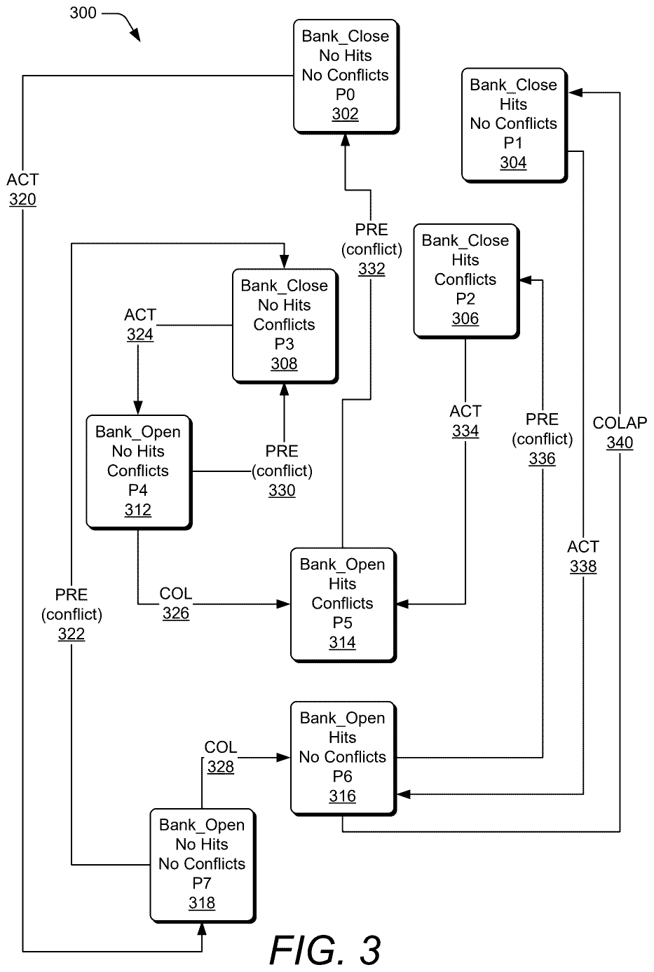

FIG. 3 illustrates a finite state machine transition diagram 300 for generating priority scores for score-based dual bank refresh arbitration. The finite state machine diagram 300 provides a logical framework for a memory controller to monitor and track the operational status of individual memory banks to determine a relative priority for refresh operations. In some implementations, the scoring logic assigns a priority score, represented here by values P0 through P7, where P0 can represent a highest priority level and P7 can represent a lowest priority level. By categorizing banks into different states based on page status, transaction history, and pending requests, the memory controller identifies banks that are available for refresh with low interference to active data traffic.

The finite state machine diagram 300 defines several states for a bank in a closed page condition, including a bank_close no hits no conflicts state 302, a bank_close hits no conflicts state 304, a bank_close hits conflicts state 306, and a bank_close no hits conflicts state 308. In the bank_close no hits no conflicts state 302, which corresponds to priority level P0, the bank is closed and currently lacks any pending read or write requests. Because this bank is already in a stable, closed state and is not being targeted by the system initiators, the scoring logic can assign it the highest priority for a refresh operation. Transitioning from this state, the memory controller can move the bank to a bank_open no hits no conflicts state 318 via an activation command transition 320 when an activation command is issued to open a row without any subsequent hits or conflicts yet identified.

Conversely, the finite state machine diagram 300 describes states for banks in an open page condition, such as a bank_open no hits conflicts state 312, a bank_open hits conflicts state 314, a bank_open hits no conflicts state 316, and the bank_open no hits no conflicts state 318. In the bank_open no hits no conflicts state 318, corresponding to priority level P7, the bank page is open but has not yet serviced any row hits or encountered conflicts. This state can occur in CPU prefetch scenarios where a row is opened in anticipation of a request that has not yet arrived. The scoring logic assigns this state the lowest priority level P7 to allow additional time for potential hits to occur before the controller forcefully closes the bank for a refresh command. If a conflict arises while in an open state, a precharge conflict transition 330 or 332 can move the bank back to a closed state, such as transitioning from state 312 to state 308 via a PRE command.

The transitions between states are driven by memory commands and traffic patterns detected by the priority tracker. Activation command transitions 320, 324, 334, and 338 occur when an ACT command is sent to a bank, changing the bank from a closed state to an open state. For example, an activation command transition 338 moves a bank from the bank_close hits no conflicts state 304 (P1) to the bank_open hits no conflicts state 316 (P6). Similarly, column command transitions 326 and 328 occur when read or write commands are issued to an open row, indicating “hits.” For instance, a column command transition 328 moves the bank from state 318 (P7) to state 316 (P6) upon the occurrence of a column access.

The finite state machine diagram 300 also utilizes precharge conflict transitions 322, 330, 332, and 336 to handle scenarios where a bank must be closed due to an idle timer or a request for a different row. A precharge conflict transition 336 moves the bank from the open state 316 (P6) to the closed state 306 (P2). Furthermore, a COLAP transition 340 can be used when a column command with auto-precharge is issued, moving a bank from the bank_open hits no conflicts state 316 directly to the bank_close hits no conflicts state 304. This set of states and transitions allows the memory controller to maintain a dynamic and real-time priority score for every bank in the system, facilitating intelligent refresh scheduling that adapts to the localized traffic hammers or sporadic idle periods of the memory subsystem.

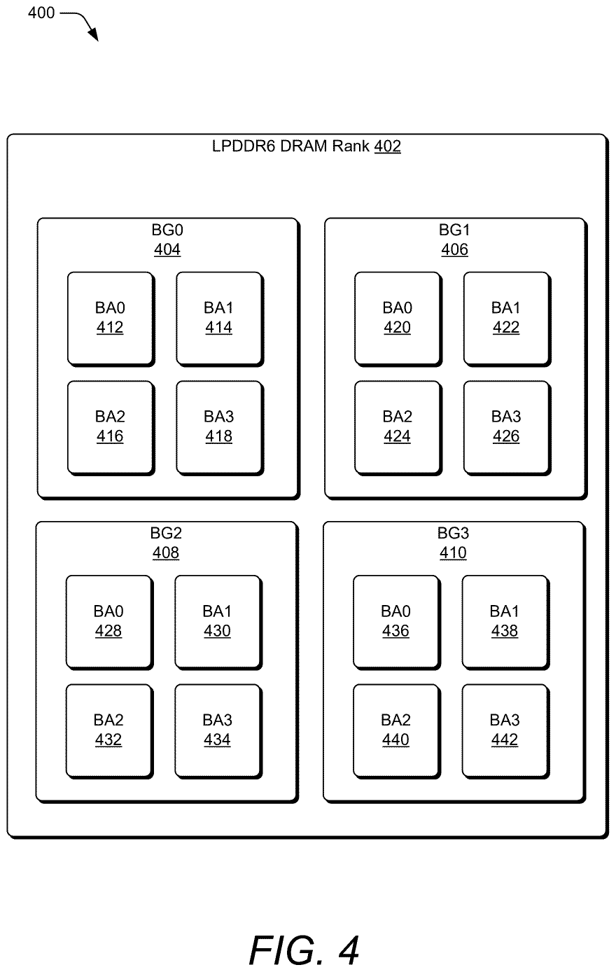

FIG. 4 illustrates an internal memory architecture 400 for an LPDDR6 DRAM bank and bank group organization suitable for score-based dual bank refresh arbitration. The internal memory architecture 400 provides a structural framework that allows a memory controller to leverage the flexibility of the LPDDR6 specification by selecting bank pairs for refresh that share a common bank address index across different logical groupings.

An LPDDR6 DRAM rank 402 serves as the primary memory unit and contains multiple logical subdivisions. In some implementations, the LPDDR6 DRAM rank 402 organizes its constituent memory banks into four distinct bank groups: a bank group 0 (BG0) 404, a bank group 1 (BG1) 406, a bank group 2 (BG2) 408, and a bank group 3 (BG3) 410. Each of these bank groups operates as a semi-independent logical cluster within the LPDDR6 DRAM rank 402.

The bank group 0 (BG0) 404 contains a first set of memory banks. Specifically, the bank group 0 (BG0) 404 includes a bank address 0 (BA0) 412, a bank address 1(BA1) 414, a bank address 2(BA2) 416, and a bank address 3(BA3) 418. These four memory banks share the common characteristic of belonging to the same physical or logical group within the first quadrant of the internal memory architecture 400.

The bank group 1 (BG1) 406 contains a second set of memory banks. The bank group 1 (BG1) 406 includes a bank address 0 (BA0) 420, a bank address 1(BA1) 422, a bank address 2(BA2) 424, and a bank address 3(BA3) 426. While these banks reside in a different bank group than the banks in BG0 404, they utilize a mirrored set of bank address indices (BA0 through BA3).

The bank group 2 (BG2) 408 contains a third set of memory banks. The bank group 2 (BG2) 408 includes a bank address 0 (BA0) 428, a bank address 1(BA1) 430, a bank address 2 (BA2) 432, and a bank address 3(BA3) 434. Similarly, the bank group 3 (BG3) 410 contains a fourth set of memory banks, including a bank address 0 (BA0) 436, a bank address 1(BA1) 438, a bank address 2(BA2) 440, and a bank address 3(BA3) 442.

The internal memory architecture 400 establishes a relationship where banks with the same bank address index (BA) are distributed across all four bank groups. For example, the bank address index BA0 is associated with bank 412 in BG0 404, bank 420 in BG1 406, bank 428 in BG 2 408, and bank 436 in BG3 410. This systematic organization provides the basis for the refresh pairing requirements of the LPDDR6 protocol, which allows the memory controller to refresh any two banks provided they share the same bank index but belong to different bank groups.

In an example operational sequence, a memory controller identifies a target bank index, such as BA0. Using the internal memory architecture 400, the controller can select any two banks from the set comprising bank 412, bank 420, bank 428, and bank 436 to satisfy a dual-bank refresh command (REFdb). For instance, the controller can pair bank BA0 412 from BG0 with bank BA0 428 from BG2. Alternatively, the controller can pair bank BA0 420 from BG1 with bank BA0 436 from BG3. The internal memory architecture 400 thus provides six possible pairing combinations for each bank address index (e.g., pairings between BG0-BG1, BG0-BG2, BG0-BG3, BG1-BG2, BG1-BG3, or BG2-BG3).

The distribution of banks within the internal memory architecture 400 allows the memory controller to avoid refreshing banks that are currently subject to high-volume read or write traffic. For example, if bank 412 and bank 420 are experiencing heavy localized hammering, the memory controller can instead select bank 428 and bank 436 for the current refresh window. This structural flexibility enables the system to maintain high throughput and reduce performance blackouts by intelligently steering refresh operations toward “cold” or idle bank groups.

The internal memory architecture 400 also supports future extensibility. While the illustrated LPDDR6 DRAM rank 402 includes sixteen banks organized into four groups, the same principles can apply to configurations with more banks or groups. For example, a larger rank could include eight bank groups, and the controller could still utilize the common bank address index to select a qualifying pair for refresh. The logical arrangement of BG0 404 through BG3 410 thus provides a predictable and scalable map for the arbitration logic to manage memory maintenance across varying DRAM densities and protocol versions.

### Example Methods

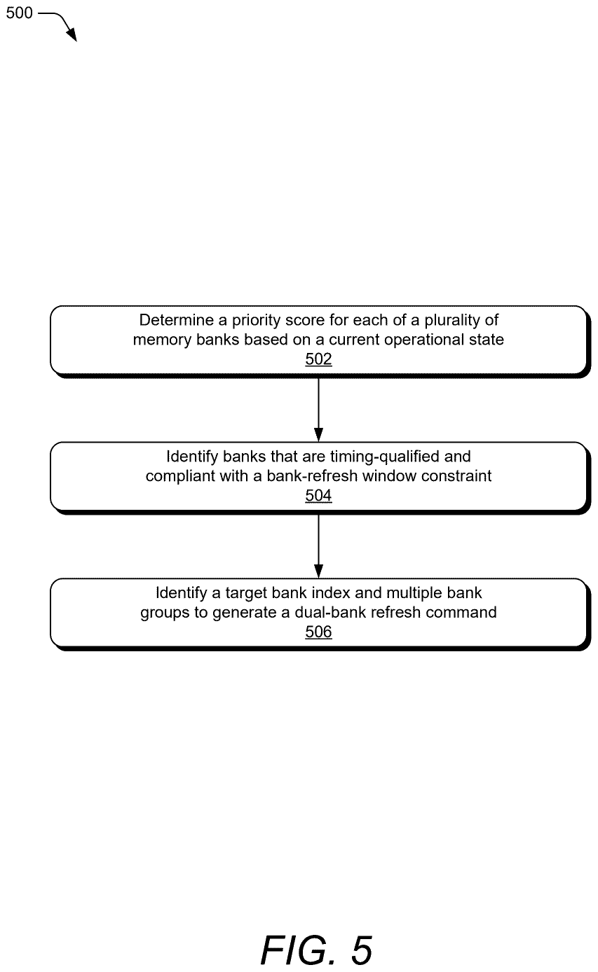

FIG. 5 illustrates an example method 500 for score-based dual bank refresh arbitration in accordance with one or more aspects. Operations of the method 500 are implemented by or with System-on-Chip 102.

Example method 500 is described with reference to FIG. 5 in accordance with one or more aspects of score-based dual bank refresh arbitration. Generally, the method 500 illustrates sets of operations (or acts) performed in, but not necessarily limited to, the order or combinations in which the operations are shown herein. Further, any of one or more of the operations may be repeated, combined, reorganized, omitted, or linked to provide a variety of additional and/or alternate methods. In portions of the following discussion, reference may be made to the entities of FIG. 1-4, reference to which is made for example only. The systems and methods described in this disclosure are not limited to embodiment or performance by one entity or multiple entities operating in relation to score-based dual bank refresh arbitration.

FIG. 5 illustrates a high-level method flowchart 500 for adaptive memory refresh for score-based dual bank refresh arbitration. The method flowchart 500 describes a sequence of operations that a memory controller can perform to intelligently select and refresh memory banks in a dynamic environment, such as a system supporting LPDDR6 memory protocols. By following these operations, a hardware device manages maintenance requirements alongside active data traffic to improve overall bandwidth availability and system responsiveness.

At 502, a score generation engine determines a priority score for each memory bank of a plurality of memory banks based on a current operational state. The score generation engine evaluates real-time telemetry from each memory bank, for example, identifying if a bank page is currently open or closed, whether the bank is receiving row hits, or whether pending requests indicate a row conflict. In some implementations, the score generation engine assigns a higher priority score to banks that are currently closed and lack pending requests, for example, a bank in an idle state that does not require a precharge command prior to a refresh. Conversely, the score generation engine can assign a lower priority score to banks that are actively being accessed by high-priority system initiators to avoid introducing bubbles in the command stream.

At 504, a filter engine identifies banks that are timing-qualified and compliant with a bank-refresh window constraint. The filter engine processes the plurality of banks to exclude candidates that cannot legally receive a refresh command due to hardware limitations or protocol requirements. For example, a timing filter within the filter engine may compare the current clock cycle against the last activation time of a bank to verify that the bank has satisfied all AC timing parameters, such as tRFC or tRP. Simultaneously, a control filter verifies compliance with a refresh window constraint by checking that a specific bank has not already been refreshed during the current cycle, which results in every bank in the memory rank being serviced before any bank is refreshed twice

At 506, an arbitration engine identifies a target bank index and multiple bank groups to generate a dual-bank refresh command. The arbitration engine processes the priority scores of the banks that remained valid after the filtering operation to select the most appropriate candidates for the maintenance operation. For example, the arbitration engine can utilize a multi-stage process where it first selects the highest-scoring bank groups for each available bank address index and then performs a weighted summation to determine which bank index offers the greatest overall benefit for the system at that specific time. This identification process concludes with a command generator issuing a refresh command, for example, an LPDDR6 REFdb command, targeting the specific bank index across the selected bank groups.

The method flowchart 500 allows for significant implementation flexibility. For example, in some cases, the memory controller can tune the scoring thresholds or the weighting of the arbitration logic based on temperature sensors or detected workload patterns to adjust the aggressiveness of the refresh scheduling. In some implementations, the memory controller may pause the method if it detects a priority system-level priority override or a power state transition. By dynamically performing these steps, the memory controller avoids the throughput loss associated with fixed-sequence refresh patterns that might otherwise collide with localized, heavy workloads.

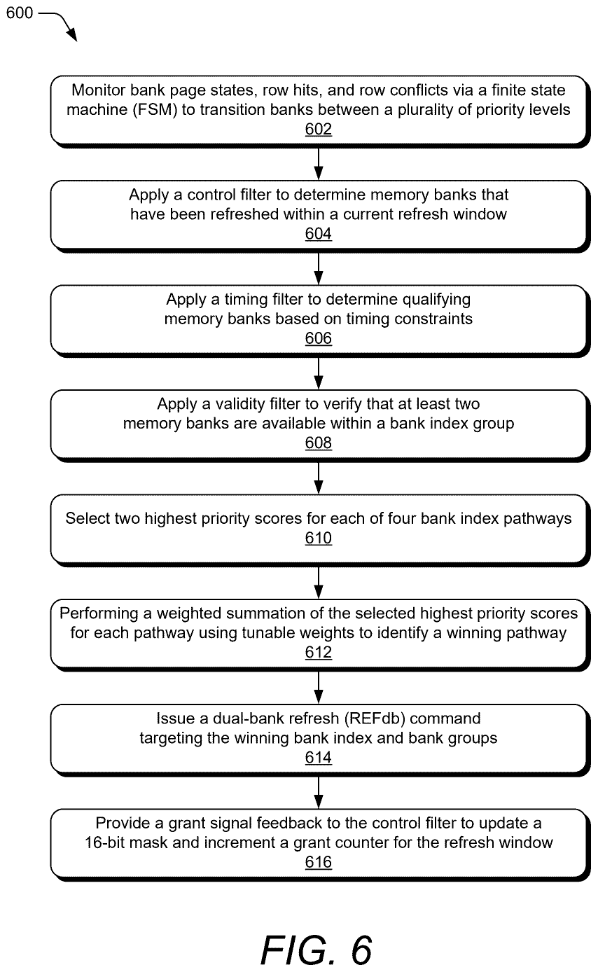

FIG. 6 illustrates an example method 600 for score-based dual bank refresh arbitration in accordance with one or more aspects. Operations of the method 600 are implemented by or with System-on-Chip 102.

Example method 600 is described with reference to FIG. 6 in accordance with one or more aspects of score-based dual bank refresh arbitration. Generally, the method 600 illustrates sets of operations (or acts) performed in, but not necessarily limited to, the order or combinations in which the operations are shown herein. Further, any of one or more of the operations may be repeated, combined, reorganized, omitted, or linked to provide a variety of additional and/or alternate methods. In portions of the following discussion, reference may be made to the entities of FIGS. 1-4, reference to which is made for example only. The systems and methods described in this disclosure are not limited to embodiment or performance by one entity or multiple entities operating in relation to score-based dual bank refresh arbitration.

FIG. 6 illustrates a detailed method flowchart 600 representing an operational sequence for score-based dual bank refresh arbitration. The detailed method flowchart 600 defines a series of logical stages implemented by a memory controller to monitor memory bank status and intelligently schedule refresh operations in a manner that reduces interference with active read and write traffic. By performing these operations, the system evaluates real-time data from a plurality of memory banks to identify candidates for refresh that provide the least overall performance penalty for system initiators.

At 602, a score generation engine monitors bank page states, row hits, and row conflicts via a finite state machine to transition memory banks between a plurality of priority levels. The score generation engine evaluates real-time transaction data and bank status indicators, for example, whether a bank is currently open, whether it is closed, whether an incoming request targets a currently open row, or whether an incoming request targets a different row in the same bank. Based on these observations, the score generation engine assigns a priority level from a set of levels, for example, P0, P1, P2, P3, P4, P5, P6, or P7. In some implementations, the score generation engine can assign a high priority like P0 to a closed bank with no traffic, whereas the score generation engine can assign a low priority like P7 to an open bank with no hits to prioritize a prefetch operation. This allows the system to identify refresh candidates that will have a lower performance impact on high-priority data streams, for example, GPU linear write workloads or CPU prefetch sequences.

At 604, a filter engine applies a control filter to determine memory banks that have been refreshed within a current refresh window. The filter engine manages a history of refresh grants to support compliance with memory standard constraints, such as the requirement to refresh every bank exactly once before repeating a refresh to the same bank. For example, the filter engine can maintain a 16-bit control_filter_mask where each bit represents a specific memory bank in a rank. If a bank has been recently serviced, the filter engine masks the corresponding bit to exclude that bank from the current arbitration cycle. The filter engine can track the progress of a refresh cycle using a counter, for example, a 3-bit num_refdb_grant register, and reset the mask once eight refresh pairs have been successfully granted.

At 606, the filter engine applies a timing filter to determine qualifying memory banks based on timing constraints. The filter engine receives timing inputs from various sources, for example, a refresh timer or internal command-to-command timers. The filter engine verifies that each bank is in a timing-qualified state, for example, by checking that enough time has passed since a row was last precharged or activated. The filter engine can evaluate specific DRAM AC timing parameters, for example, tRC (row cycle time), tRP (row precharge time), or tRRD (row-to-row delay). If a bank does not satisfy these timing requirements, the filter engine invalidates the request for that bank for the current cycle to avoid command collisions or protocol violations.

At 608, the filter engine applies a validity filter to verify that at least two memory banks are available within a bank index group. In environments where the memory protocol requires refreshing banks in pairs that share a common bank address index, the filter engine requires that a sufficient number of banks remain eligible within each logical pathway. For example, the validity filter monitors the outputs of the control and timing filters for a specific address index, such as BA0. If only one bank group within the BA0 group is valid, the validity filter invalidates all bank group requests for that index. This verification process restricts the subsequent arbitration logic to considering only pathways that generate a valid dual-bank command, such as by having at least two available bank groups like BG0 and BG2.

At 610, an arbitration engine selects two highest priority scores for each of four bank index pathways. The arbitration engine processes the scores of banks that have survived the filtering stages to identify the best candidates for refresh within each address group. For example, the arbitration engine can utilize parallel arbiters, for example, four parallel top 2 arb modules, to evaluate scores across sixteen banks organized by their bank address indices BA0, BA1, BA2, and BA3. Within each index group, the arbitration engine identifies a pair of bank groups, for example, BG1 and BG3, that provide the highest priority scores. These selected winners represent the most beneficial pair to refresh if that specific address index is eventually chosen by the final arbitration stage.

At 612, the arbitration engine performs a weighted summation of the selected highest priority scores for each pathway using tunable weights to identify a winning pathway. The arbitration engine aggregates the priority scores of the previously identified bank group pairs to calculate a total score for each address index. For example, the arbitration engine can apply multipliers or offsets provided by a control status register to prioritize certain bank addresses based on current workload types, thermal sensors, or environmental metrics like DRAM temperature. The arbitration engine then compares the weighted sums using a final arbiter, for example, a 4:1 score arb module, to select a winning pathway. The arbitration engine identifies the specific bank address, for example, BA2, and its associated two winning bank groups as the final selection for the refresh command.

At 614, a command engine issues a dual-bank refresh (REFdb) command targeting the winning bank index and bank groups. The command engine formats a memory command according to the appropriate communication protocol, for example, the LPDDR6 JEDEC standard. For example, the command engine can generate a command packet that includes the target bank address bits and the bank group selection bits for the two chosen groups. The command engine transmits this dual-bank refresh command to the memory rank, for example, an LPDDR6 DRAM rank. By targeting the banks selected through the scoring and arbitration process, the command engine helps the system refresh banks that are not currently being hammered by localized linear accesses, thereby mitigating performance blackouts.

At 616, the command engine provides a grant signal feedback to the control filter to update a 16-bit mask and increment a grant counter for the refresh window. When a refresh operation is granted, the command engine notifies the filtering logic to prevent the targeted banks from being prioritized for immediate subsequent refreshes. For example, the command engine asserts a grant signal that causes the filter logic to update its control_filter_mask, marking the two refreshed banks as temporarily ineligible. The command engine also triggers an increment of a grant counter, for example, num_refdb_grant, to track the total number of refresh commands sent during the current refresh interval. This feedback mechanism maintains an accurate record of refreshed banks and resets the scheduling cycle once every bank has been successfully serviced.

### Conclusion

Although aspects of score-based dual bank refresh arbitration has been described in language specific to features and/or methods, the subject of the appended claims is, as recited by any of the previous examples, not necessarily limited to the specific features or methods described. Rather, the specific features and methods are disclosed as example implementations of score-based dual bank refresh arbitration, and other equivalent features and methods are intended to be within the scope of the appended claims. Further, various aspects of score-based dual bank refresh arbitration are described, and it is to be appreciated that each described aspect may be implemented independently or in connection with one or more other described aspects.

What is claimed is:

1. An apparatus comprising:
score generation logic configured to generate a priority score for each of a plurality of memory banks based on an operational state of each memory bank;
a filtering stage configured to identify a set of eligible memory banks from the plurality of memory banks based on at least one timing constraint or a refresh window constraint;
arbitration logic configured to select a target bank index and a plurality of bank groups from the set of eligible memory banks based on arbitration of the priority scores; and
a command engine configured to issue a dual-bank refresh command based on the target bank index and the plurality of bank groups.

2. The apparatus of claim 1, wherein the score generation logic comprises a plurality of finite state machines (FSMs), each FSM configured to track the operational state for a respective memory bank and assign the priority score based on whether a bank page is open or closed, whether a current request is a row hit, or whether a current request is a row conflict.

3. The apparatus of claim 2, wherein the FSM assigns higher priority scores to memory banks in a closed bank page state than to memory banks in an open bank page state.

4. The apparatus of claim 2, wherein the FSM assigns a lowest priority score to a memory bank in an open bank page state having no hits and no conflicts to prioritize a prefetch operation.

5. The apparatus of claim 1, wherein the plurality of memory banks are partitioned into a plurality of bank index groups, each bank index group comprising memory banks from different bank groups that share a common bank index.

6. The apparatus of claim 5, wherein the arbitration logic comprises:
a first stage of parallel arbiters, each parallel arbiter configured to select two highest priority scores from a respective bank index group; and
a second stage arbiter configured to select the target bank index based on a weighted summation of the selected highest priority scores from each bank index group.

7. The apparatus of claim 1, wherein the filtering stage comprises a control filter configured to mask memory banks that have been refreshed within a current refresh window until a predetermined number of refresh grants have occurred.

8. The apparatus of claim 1, wherein the filtering stage comprises a validity filter configured to invalidate refresh requests for a bank index group if fewer than two memory banks in the bank index group are identified as eligible memory banks.

9. The apparatus of claim 1, wherein the score generation logic, the filtering stage, the arbitration logic, and the command engine comprise digital logic circuitry integrated within a memory controller, and wherein the priority scores are mapped from priority levels using tunable control status registers.

10. The apparatus of claim 1, wherein the dual-bank refresh command is a REFdb command compliant with a Low Power Double Data Rate 6(LPDDR 6) standard.
